(19) United States
(12) Patent Application Publication
(10) Pub. No.: US 2002/0072981 A1
(43) Pub. Date: Jun. 13, 2002

(54) Search engine adapted to permit real time querying of a set of internet sites

(76) Inventors: Jin Y. Park, Portland, OR (US); Dirk T. Knudsen, Portland, OR (US)

Correspondence Address: TIMOTHY E SIEGEL, 1868 KNAPPS ALLEY, SUITE 206, WEST LINN, OR, 97068, US

(21) Appl. No.: 09/734,831

(22) Filed: Dec. 11, 2000

(51) Int. Cl. G06F 17/60

(52) U.S. Cl. 705/26

(57) ABSTRACT

A real time Internet search engine program, comprising computer readable media bearing a user interface, adapted to prompt a user to enter a set of Internet sites to be searched and a type of data to be collected. An Internet site-accessing element accesses the Internet sites to gather the type of data to be collected, in real time, and a display interface displays the gathered data to the user. By using real time techniques for accessing data from various end use web sites, it is possible to offer users a search engine, without the need to compile of a large search engine data base.

### BACKGROUND OF THE INVENTION

Search engines have a common application in the form of intelligent shopper programs in which a user is permitted to compare prices from a number of online vendors in order to choose the best offer. After seeing a display of anticipated offers, the user may select one and then be forwarded to the Internet site posting the chosen offer, to finish the deal. It should be noted that in this application the term “search engine” includes intelligent shopper programs and other programs that gather information from the Internet.

Up until now, two generations of search engines have been introduced. The first generation is simple information listing engines, such as Yahoo® that produce a list of web sites in response to a query by a user. The second generation is personalized information gathering devices, such as the Yahoo® personalized Palm Pilots® in which each search is framed by a profile that the user has entered.

Typically, an intelligent shopper search engine web site maintains and constantly updates its own database of price and selection information. When a user contacts the web site, he actually searches through this database, rather than through the databases maintained by the Internet sites that are represented by the intelligent shopper program.

Unfortunately, a number of problems present themselves with this type of program. First, it is difficult to maintain a database as large, complete and up-to-date as the databases on all of the Internet sites being searched. As a result, information returned to the user may be out-of-date and incomplete relative to what he could have found by visiting the web sites individually.

A second problem is encountered when the user decides that he wishes to act on one of the displayed offers. Typically a user would click on the offer display using the computer mouse. At this point the screen is displayed from the Internet site from which he wishes to make a purchase. In some instances the home page of the Internet site is displayed and the user must then navigate his way through the site to the page upon which the desired product is displayed. In other instances, the page displaying the product of interest is displayed. The user, however, must still select the item he wishes to purchase, click on the button to go to the checkout screen, and complete the checkout information. It would be more efficient to go straight to the checkout screen with the item selected, but this is typically not an option with most intelligent shopper programs.

With respect to the first problem cited above, it would be possible to conceive of a system in which web sites of interest were searched in real time in response to a user request. This does not appear, however, to be part of the prior art. This may be because of a number of technical difficulties that are encountered in an attempt to implement such a system. First, many merchant web sites maintain a number of separate databases. A large central database may be maintained for searches of all the inventory of the merchant web site, while more specific databases are maintained for specific product types.

For example, in the Amazon.com® web site, a user may perform a search of all products or may limit his search to just books, videos or auctions among other categories. Although this author does not know that separate databases are maintained by Amazon.com®, a general search did not always return the same information as a search in an individual category of goods. For example, a general search for “Harry Potter” returned some auction items that were not returned in a more specific search of the auction items only. In addition, in a general search a number of movies that were directed by an H. C. Potter were returned. For those customers searching for books in the popular “Harry Potter” series by J. K. Rowling this type of search result only serves to distract and confuse.

Moreover, information about the book, such as the sales price, may be kept at a still deeper level of data, within the database or set of databases. In order to increase chances of a speedy and well directed search, it would be beneficial to have a method for directing the search to the specific data base maintained by a to-be-searched web site that corresponds to the product type towards which the search is directed. In addition, it would be beneficial to be able to reach the deeper data level, to obtain the sales price. This, again, does not appear to be part of the prior art.

With respect to the second problem, that of directing the user to only a preliminary screen, it would be advantageous to have a method of directing a user to the checkout screen of a web site, and to automatically configure the checkout screen to permit the rapid purchase of the selected item.

It may, however, be difficult to implement a system in which servers or “web sites” are checked repeatedly for price information without running afoul of the systems maintained by web sites to limit the search server access to pages that are deep within the site. If a person is browsing the web and visits a web site, that web site typically sends a “cookie,” meaning a small data file having a predefined structure including an ID tag, to the search server. Popular browsers, such as the Netscape Navigator and Microsoft Internet Explorer store the cookies on the client HTML.

Web sites typically screen users by the ID tags of their cookies. The range of acceptable ID tags is typically changed regularly so that only users with recently issued cookies from a specific page can access that page. This is why it is typically possible to return (by use of a browsers “back” button) to recently visited web pages, but not to those pages visited longer ago.

In addition many web sites require that in order to reach a particular page (“page c”, for example), one must pass through a specific sequence of pages “page a” and “page b,” to continue the example. In order to enforce this route of travel, the web site modifies the ID tag each time the user travels from a one page to another. When the user tries to enter page c, he must have an ID tag that reflects this path of travel.

These features of web sites can prove an encumbrance to those attempting to do rapid targeted searching over a range of web sites. For example, without an appropriate cookie, the “book” database of a general merchandise web site may not be directly available. Accordingly, a search engine would have to access a number of screens or pages to get to a database of interest, thereby slowing down the search process.

### SUMMARY

In a first separate aspect, the present invention is a real time Internet search engine program, comprising computer readable media bearing a user interface, adapted to prompt a user to enter a set of Internet sites to be searched and a type of data to be collected. An Internet site accessing element accesses the Internet sites to gather the type of data to be collected, in real time and a display interface displays the gathered data to the user. By using real time techniques for accessing data from various end use web sites, it is possible to offer users a search engine, without the need to compile of a large search engine data base.

In a second separate aspect the present invention is an Internet search engine program, comprising computer readable media bearing a user interface code element, adapted to prompt a user to enter a set of Internet sites to be searched and a type of data to be collected. The program also includes an Internet site accessing element for accessing the Internet sites and a cookie manipulation element adapted to manipulate a cookie for at least one of the Internet sites so that the accessing of the one of the Internet sites is improved for accessing the type of data to be collected relative to the accessing of the Internet site for the type of data to be collected absent the manipulation.

In a third separate aspect, the present invention comprises an Internet search engine, comprising computer readable media bearing a user interface, which prompts a user to enter an Internet site from a list of Internet sites and to specify an action to be performed at the Internet site. The search engine also includes an Internet site accessing element for accessing the Internet site. Finally, a cookie manipulation element manipulates a cookie so that the accessing of the Internet site and the performance of the action is facilitated.

In a fourth separate aspect the present invention is an intelligent shopper program, comprising computer readable media bearing a user interface, adapted to present on a display prompts for directing a user to input an item to be searched for and to pick a set of web sites to be searched. The program also includes a web site accessing element, adapted to access a set of web sites and to retrieve web site offerings and cookies from the web sites and a cookie storage element, adapted to store cookies received from the web sites during the search. In addition, further user interface elements display the price information permit a user to input a choice from the web site offering. Finally, a checkout-accessing element accesses the checkout of a selected web site and forwards to it prospective purchase information.

In a fifth separate aspect, the present invention is a method of permitting an Internet user to gather information and to make a purchase from one of a set of web sites, each having a checkout page. The method comprises prompting a user to input an item to be searched for and a set of web sites to be searched and accepting user input for the item and the set of web sites. A set of web sites is accessed and web site offerings are retrieved for the item and cookies from the web sites. The cookies and the web site offerings are stored and displayed and the user is permitted to pick any of the web site offerings. Finally, the checkout page is accessed for the picked web site offerings and a corresponding cookie is forwarded to the checkout page.

The foregoing and other objectives, features and advantages of the invention will be more readily understood upon consideration of the following detailed description of the invention, taken in conjunction with the accompanying drawings.

### BRIEF DESCRIPTION OF THE DRAWINGS

FIG. 1 is a block diagram showing the structure of the client computer, search engine and searchable web sites with which the present invention is implemented.

FIG. 2 is a rendering of a computer display for the first choice screen of the search engine of the present invention.

FIG. 3 is a rendering of a computer display for the second choice screen of the search engine of the present invention.

FIG. 4 is a block diagram of the structure of a web site to be searched by the present invention.

### DETAILED DESCRIPTION OF THE PREFERRED EMBODIMENT

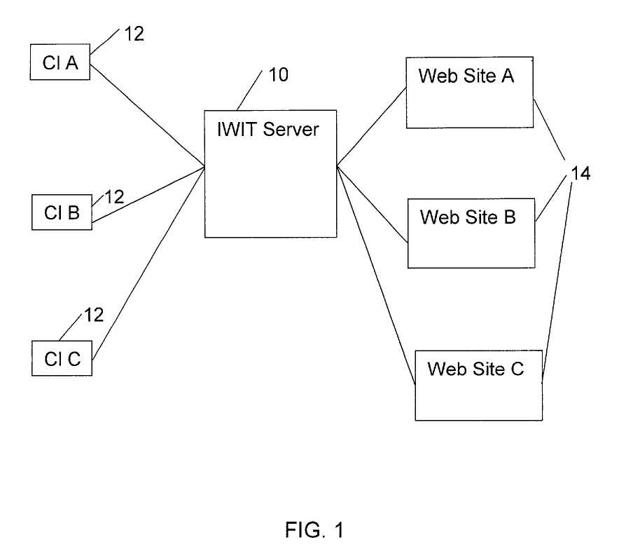

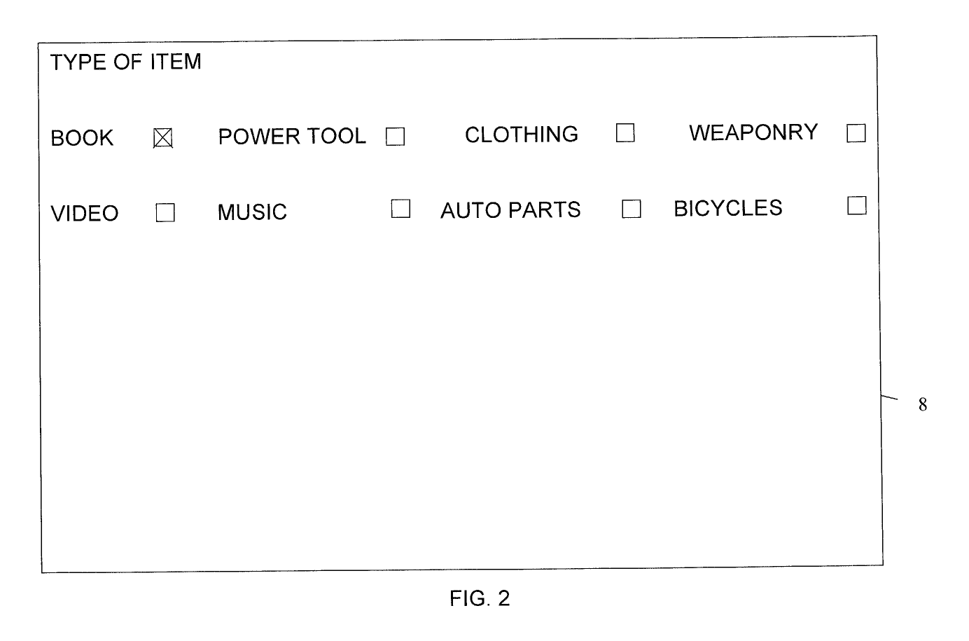

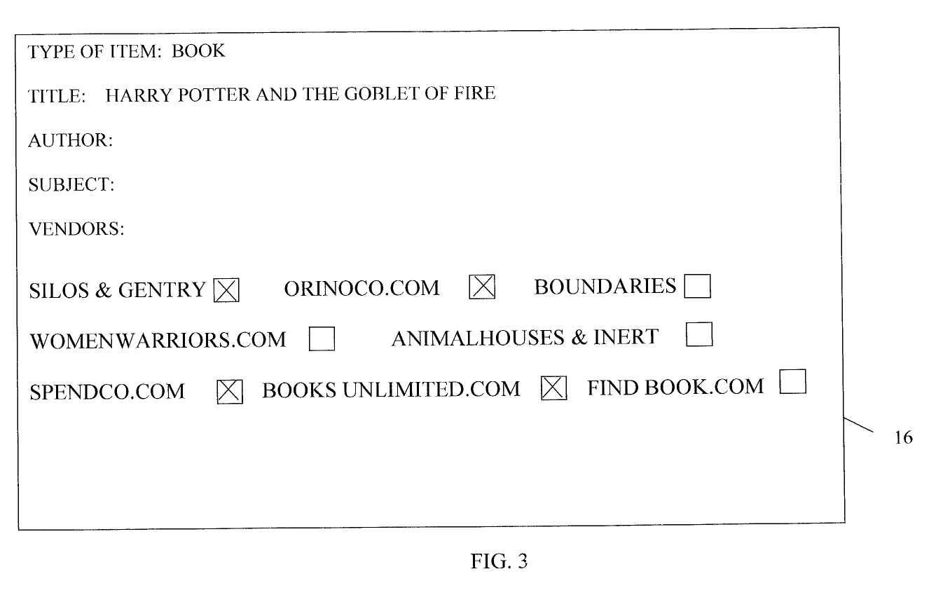

Referring to FIGS. 1 and 2, a typical search performed in accordance with the present invention would begin with a beginning display 8, downloaded from a search engine server 10 to a client computer 12, of various items that could be searched for on web sites 14. FIG. 3 shows a subsequent display 16 encountered by a user on client computer 12, who has chosen “books” as the category of goods to be searched. The user has also filled out the title or author of the book to be searched for and has selected a number of online vendors at whose servers the search is to be performed.

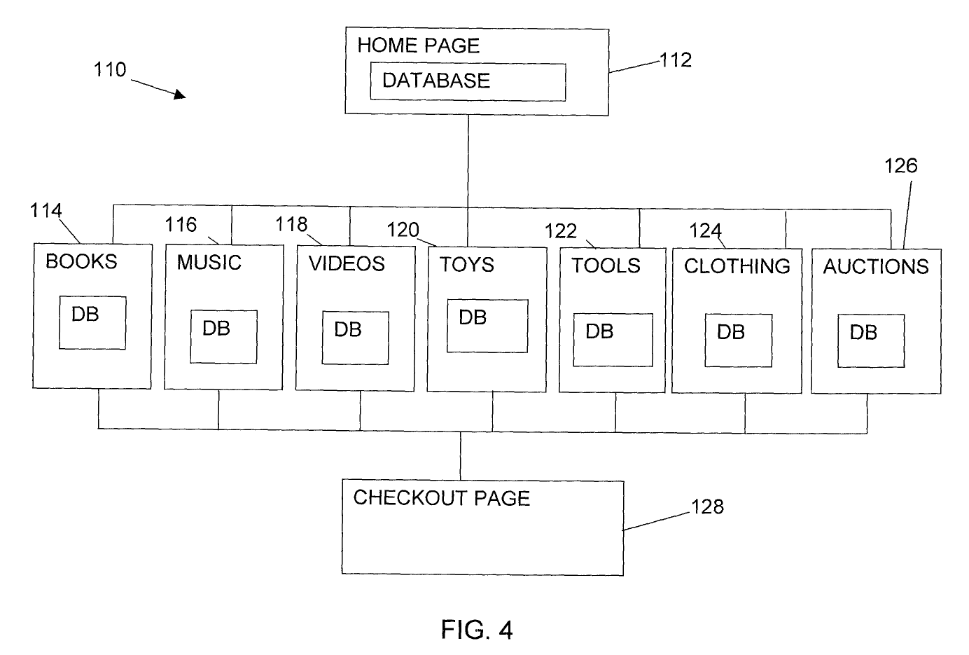

Subsequently, the selected servers are contacted by way of the Internet, and a request is made at each server to search for the book and to return a price quote for the book. A typical web site structure 110 is shown in FIG. 4. A home page 112 presents the display that most users will see when first contacting this page. This may not be the page upon which the information of interest may be accessed, however. In this example, the information of interest is included on the books page 114. Other pages on this web site include music 116, videos 118, toys 120, tools 122, clothing 124 and auctions 126. Finally a “checkout” page 128 permits a user to pay for his purchases.

To make these requests, however, the search computer program needs to have some information about each web site of interest. First, the search computer program needs to know how to access the database of interest, in this instance the database that is dedicated to the cataloging of books, in particular (see FIG. 3). It may not be possible to reach this database, however, absent the manipulation of a cookie on the search computer.

A cookie is an item of information that is sent from a server (web site) to a client (user computer). Typically a cookie will have a name, an expiration time and further information. For example:

Cookie: ID=xyxxox

Domain=orinoco.com

Path=/books

Expires=Aug. 2, 2002 18:55:44

Item=Harry Potter and the Goblet of Fire

Shipping=FedEx

In this instance the cookie identifies a customer ID, indicates that the cookie has been sent by orinoco.com, more specifically indicates that in the future access may be had through the path /books (at orinoco.com), gives a time when the cookie will expire and no longer be valid, indicates an item that the user wants and a shipper that the user has indicated he would like to use. In this instance, the ID tag may be accepted only for 20 minutes, by the server, even though this might not equal the expires time. Accordingly, if the user wishes to visit the books portion of the Orinoco database again, after 20 minutes has passed, he must have a way of updating the ID tag. In order to change the ID tag, the user must have an understanding of the system that the web site of interest has in the way it issues ID tags.

Most web sites have a predetermined pattern in the way in which they issue cookie ID tags. This pattern may be dependent both on time duration spent in the site and on travel within the site. For example, a web site could issue an ID tag consisting of two eight bit words, with the first word being a time stamp and the second word being manipulated according to the user's travel through the web site. The 8 bit time stamp could break the 24 hour day into 256 uniform 5 minute, 37.5 second intervals, and could be incremented after each one of these intervals. Mimicking this time stamp would be easy, simply by determining the time of day and the corresponding word. For example, if the time were 11:05 AM, this would be placed in the 118^{th} time interval, yielding a word of 01110110. In another 4 minutes and 22.5 seconds, however, this word would need to be incremented in order for the user to continue to use the web site. A scheme like this is, of course, easily predictable at all times.

As noted above, some web sites regulate travel from page to page through the web site by modifying ID tags as the user travels from one page to another. For example, as the user moves from a page A to a page B the travel-noting portion of the ID tag is ANDed with the word 10101010. As the user moves from page B to page C, the ID tag is NORed with the word 00110110. Accordingly, if the original ID tag were 11001110, then going from A to B would result in the operation:

11001110 AND 10101010=10001010.

Similarly, going from B to C results in the operation:

10001010 NOR 00110110=01000001.

Consequently, to go directly to page C from outside of the web site, one could use the ID tag travel portion of 0100001 and examine information on the C page. If one were to do this at 11:05 AM the time stamp portion would have to equal 01110110.

The search engine determines this pattern by, upon request, visiting the web site page of interest to receive a new cookie with an updated ID tag. Programmers maintaining the search engine then perform standard pattern recognition to determine the pattern of the changes in the ID tags. This may include NANDing, NORing and XORing the old and new ID tags together to help determine the pattern of change.

In addition it may be necessary to go to a deeper level of data storage in order to extract the price information for the item of interest. This process may be dubbed hierarchical depth control. With some subject web sites this will be the same exercise as going to a particular page. The search engine uses its heuristics to manipulate the ID tags in order to reach this deeper level and extract the price information.

Finally, after returning the information to the search server, the user is given the option of choosing from a set of web sites that offer the item of interest. By having knowledge of the cookie ID tag change pattern, the search engine is able to download the checkout page with the information about the desired purchase already filled in. This presents a great advantage over presently available systems; in which the user must typically navigate through at least one page, and sometimes several pages of the web site from which he wishes to make the purchase, before arriving at the checkout page to finalize his purchase.

One great advantage of collecting information from web sites in real time and in response to user requests is that it removes the necessity of compiling a vast database on information from the web sites. Not only is such a database impossible to maintain in complete accuracy, but the action of keeping it updated to the extent possible is a very labor intensive, and therefore expensive, process.

The terms and expressions which have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims which follow. It should be specifically noted, as well, that the term “set” includes sets having a single element only, as well as sets having a plurality of elements.

1. A real time Internet search engine program, comprising computer readable media bearing the following code elements:
(a) a user interface, adapted to prompt a user to enter a set of Internet sites to be searched and a type of data to be collected;
(b) an Internet site accessing element for accessing said Internet sites to gather said type of data to be collected, in real time; and
(c) a display interface for displaying said gathered data to said user.

2. The Internet search engine program of claim 1, further comprising magnetic media bearing a cookie manipulation element adapted to manipulate a cookie for at least one of said Internet sites so that said accessing of said one of said Internet sites is improved for accessing said type of data to be collected.

3. The Internet search engine of claim 2 wherein said cookie includes an ID Tag and wherein said cookie manipulation element is adapted to replace said ID tag of said cookie with a revised ID Tag adapted to permit continued access to said type of data to be collected.

4. The Internet search engine of claim 1, further adapted to perform an action on a user indicated web site and further comprising a cookie manipulation element adapted to manipulate a cookie for said Internet site so that said accessing of said Internet site and the performance of said action is facilitated.

5. The Internet search engine of claim 1, wherein, due to the ability to collect information in real time, there is no data-base of information gathered from web sites.

6. An intelligent shopper program, comprising computer readable media bearing the following code elements:
(a) a graphical user interface, adapted to present on a display prompts for directing a user to input an item to be searched for and to pick a set of web sites to be searched;
(b) a web site accessing element, adapted to access a set of web sites and to retrieve web site offerings and cookies from said web sites;
(c) a cookie storage element, adapted to store cookies received from said web sites during said search;
(d) further graphical user interface elements, adapted to display said price information permit a user to input a choice from said web site offerings; and
(e) a checkout accessing element, adapted to access the checkout of a selected web site and to forward prospective purchase information to said checkout.

7. A method of permitting an Internet user to gather information and to make a purchase from one of a set of web sites, each having a checkout page, said method comprising:
(a) prompting a user to input an item to be searched for and to pick a set of web sites to be searched and accepting user input for said item and said set of web sites;
(b) accessing said set of web sites and retrieving web site offerings for said item and cookies from said web sites;
(c) storing and displaying said cookies and said web site offerings
(d) permitting a user to pick any of said web site offerings; and
(e) accessing said checkout page for said picked web site offerings and forwarding to said checkout pages a corresponding cookie.
